(19) United States
(12) Patent Application Publication
(10) Pub. No.: US 2015/0200616 A1
(43) Pub. Date: Jul. 16, 2015

(54) MOTOR CONTROLLER AND METHOD FOR CONTROLLING MOTOR

(71) Applicant: KABUSHIKI KAISHA YASKAWA DENKI, Kitakyushu-shi (JP)

(72) Inventors: Takahiro SAEKI, Kitakyushu-shi (JP); Hideaki IURA, Kitakyushu-shi (JP)

(73) Assignee: KABUSHIKI KAISHA YASKAWA DENKI, Kitakyushu-shi (JP)

(21) Appl. No.: 14/557,452

(22) Filed: Dec. 2, 2014

(30) Foreign Application Priority Data
Jan. 15, 2014 (JP) 2014-005439

(51) Int. Cl. H02P 21/14

(52) U.S. Cl. CPC H02P 21/146

(57) ABSTRACT

A motor controller includes an evaluation value calculator and an evaluation value searcher. The evaluation value calculator calculates an evaluation value represented by a function including a q-axis current value of a torque current component of a current through an induction motor. The evaluation value has a first sign among a positive sign and a negative sign when a rotational speed of the induction motor is greater than a frequency of a voltage applied to the induction motor by a predetermined amount, and has a second sign when the rotational speed is smaller than the frequency by the predetermined amount. The evaluation value searcher performs an evaluation value search to increase or decrease the frequency based on whether the evaluation value has the positive or negative sign so as to make the frequency close to the rotational speed of the induction motor in a free run state.

### CROSS-REFERENCE TO RELATED APPLICATIONS

The present application claims priority under 35 U.S.C. §119 to Japanese Patent Application No. 2014-005439, filed Jan. 15, 2014. The contents of this application are incorporated herein by reference in their entirety.

### BACKGROUND

1. Field of the Invention

The embodiments disclosed herein relate to a motor controller and a method for controlling a motor.

2. Discussion of the Background

Japanese Unexamined Patent Application Publication No. 2007-159231 discloses that an induction motor in a free run state is turned into a V/F control state, and before the induction motor is turned into the V/F control state, a speed search is performed. In the speed search, the frequency of a voltage applied to the induction motor is made close to the rotational speed of the induction motor in the free run state.

### SUMMARY

According to one aspect of the present disclosure, a motor controller includes an evaluation value calculator and an evaluation value searcher. The evaluation value calculator is configured to calculate an evaluation value represented by a function including a q-axis current value of a torque current component of a current through an induction motor. The evaluation value has a first sign among a positive sign and a negative sign when a rotational speed of the induction motor is greater than a frequency of a voltage applied to the induction motor by a predetermined amount. The evaluation value has a second sign different from the first sign among the positive sign and the negative sign when the rotational speed is smaller than the frequency by the predetermined amount. The evaluation value searcher is configured to execute an evaluation value search to increase or decrease the frequency based on whether the evaluation value has the positive sign or the negative sign so as to make the frequency close to the rotational speed of the induction motor in a free run state.

According to another aspect of the present disclosure, a motor controller includes a previous searcher and a post-searcher. The previous searcher is configured to perform at least one of a first search and a second search. The first search is to increase or decrease a frequency of a voltage applied to an induction motor based on an induced voltage attributed to a residual magnetic flux that results when the induction motor turns into a free run state. The second search is to increase or decrease the frequency based on an oscillation of a current that results when a DC voltage is applied to the induction motor in the free run state. The post-searcher is configured to perform a third search after the at least one of the first search and the second search. The third search is to increase or decrease the frequency based on a q-axis current value of a torque current component of a current through the induction motor so as to make the frequency close to a rotational speed of the induction motor in the free run state.

According to another aspect of the present disclosure, a motor controller includes an evaluation value calculator and an evaluation value searcher. The evaluation value calculator is configured to calculate an evaluation value represented by a function including a q-axis power value of a torque power component of power supplied to an induction motor. The evaluation value has a first sign among a positive sign and a negative sign when a rotational speed of the induction motor is greater than a frequency of a voltage applied to the induction motor by a predetermined amount. The evaluation value has a second sign different from the first sign among the positive sign and the negative sign when the rotational speed is smaller than the frequency by the predetermined amount. The evaluation value searcher is configured to perform an evaluation value search to increase or decrease the frequency based on whether the evaluation value has the positive sign or the negative sign so as to make the frequency close to the rotational speed of the induction motor in a free run state.

According to the other aspect of the present disclosure, a method is for controlling a motor. The method includes calculating an evaluation value represented by a function including a q-axis current value of a torque current component of a current through an induction motor. The evaluation value has a first sign among a positive sign and a negative sign when a rotational speed of the induction motor is greater than a frequency of a voltage applied to the induction motor by a predetermined amount. The evaluation value has a second sign different from the first sign among the positive sign and the negative sign when the rotational speed is smaller than the frequency by the predetermined amount. An evaluation value search is performed to increase or decrease the frequency based on whether the evaluation value has the positive sign or the negative sign so as to make the frequency close to the rotational speed of the induction motor in a free run state.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram illustrating an exemplary motor control system;

FIG. 2 is a block diagram illustrating an exemplary motor controller;

FIG. 3A is a graph of an exemplary function representing an evaluation value;

FIG. 3B is an enlarged graph of a main part of FIG. 3A;

FIG. 4 is a block diagram illustrating an exemplary evaluation value searcher;

FIG. 5 is a time chart illustrating an exemplary speed search;

FIG. 6 is a time chart illustrating an exemplary speed search; and

FIG. 7 is a time chart illustrating an exemplary speed search.

### DESCRIPTION OF THE EMBODIMENTS

The embodiments will now be described in detail with reference to the accompanying drawings, wherein like reference numerals designate corresponding or identical elements throughout the various drawings.

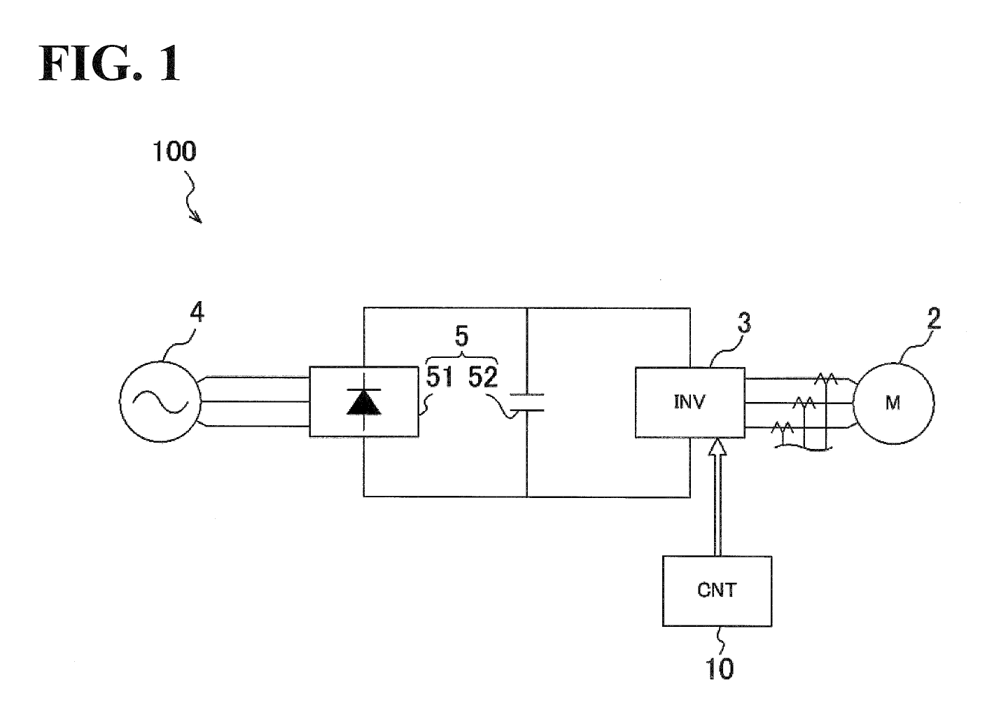

FIG. 1 is a block diagram illustrating a motor control system 100. The motor control system 100 includes an induction motor 2, an inverter 3, an AC (Alternating Current) power supply 4, a converter 5, and a motor controller 10.

The inverter 3 includes a three-phase bridge circuit to convert DC (Direct Current) power supplied from the converter 5 into AC power based on a control signal generated by the motor controller 10. Then, the inverter 3 outputs the converted AC power to the induction motor 2.

The converter 5 includes a rectifier circuit 51 and a capacitor 52. The converter 5 converts AC power supplied from the AC power supply 4 into DC power. Then, the converter 5 outputs the converted DC power to the inverter 3.

The motor controller 10 includes a microprocessor, for example. The motor controller 10 performs information processing based on a program stored in a memory, so as to generate a control signal to control the rotation of the induction motor 2. Then, the motor controller 10 outputs the generated control signal to the inverter 3.

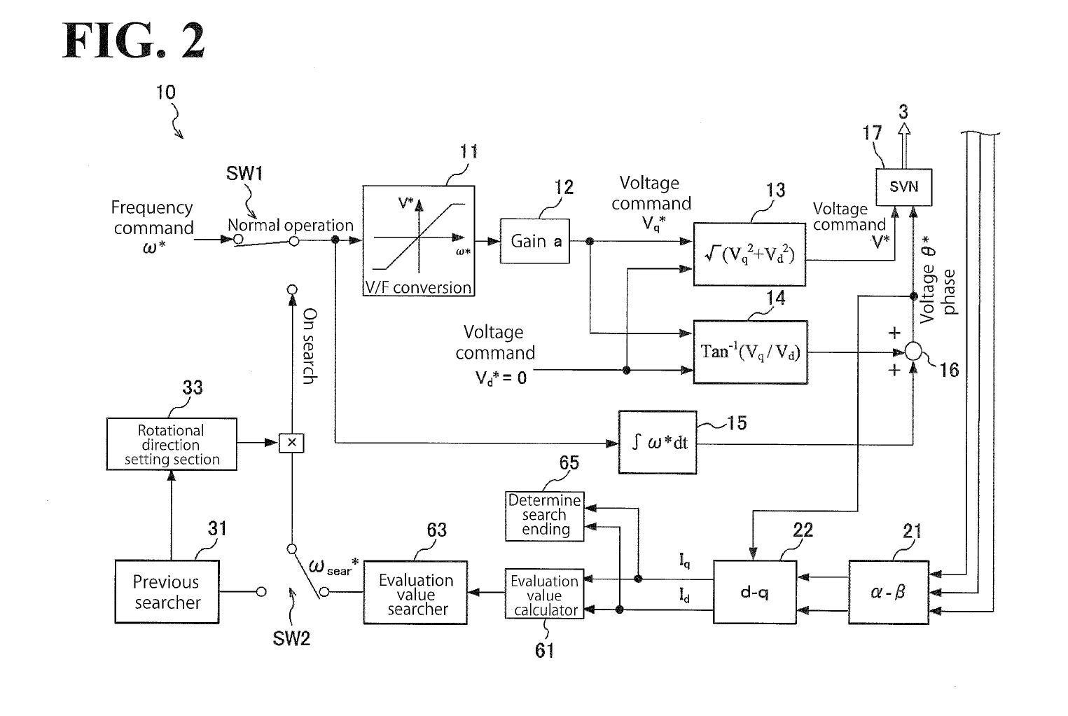

FIG. 2 is a block diagram illustrating an example of the motor controller 10. Each block of the motor controller 10 is implemented by the microprocessor performing the information processing based on the program stored in the memory.

The motor controller 10 performs a normal operation when a switch SW1 is at one side, and performs a speed search when the switch SW1 is another side. In the normal operation, the motor controller 10 performs V/F control to keep a constant ratio of a voltage V

applied to the induction motor 2 to the frequency of the applied voltage V.

The speed search is a mode in which the induction motor 2 is turned from a free run state into a V/F control state. In the free run state, the induction motor 2 is not supplied power but keeps rotation by inertia.

The motor controller 10 includes a V/F converter 11, a gain section 12, a voltage commander 13, a voltage phase section 14, an integrator 15, an adder 16, and a PMW controller 17. These blocks are in particular for implementing the normal operation. The motor controller 10 includes an α-β converter 21 and a d-q converter 22.

The motor controller 10 includes a previous searcher 31 and a rotational direction setting section 33. These blocks are for implementing a previous search. The previous search is a part of the speed search.

The motor controller 10 includes an evaluation value calculator 61, an evaluation value searcher 63, and a search ending determiner 65. These blocks are for implementing an evaluation value search. The evaluation value search is also a part of the speed search.

The V/F converter 11 performs V/F conversion of a frequency command ω*, which is obtained from an upper-level system, so as to generate a q-axis voltage base value. Then, the V/F converter 11 outputs the q-axis voltage base value to the gain section 12.

The gain section 12 receives the q-axis voltage base value from the V/F converter 11, and multiplies the q-axis voltage base value by a gain a so as to calculate a q-axis voltage command V_{q}*. Then, the gain section 12 outputs the q-axis voltage command V_{q}* to the voltage commander 13 and the voltage phase section 14.

The voltage commander 13 calculates a voltage command V* based on the q-axis voltage command V_{q}* from the gain section 12 and based on a d-axis voltage command V_{d}* (=0) from the upper-level system. Then, the voltage commander 13 outputs the voltage command V* to the PMW controller 17.

The voltage phase section 14 calculates a voltage phase correction value based on the q-axis voltage command V_{q}* from the gain section 12 and based on the d-axis voltage command V_{d}* (=0). Then, the voltage phase section 14 outputs the correction value to the adder 16.

The integrator 15 integrates the frequency command a)* to calculate a voltage phase base value. Then, the integrator 15 outputs the voltage phase base value to the adder 16.

The adder 16 adds the voltage phase correction value obtained from the voltage phase section 14 to the voltage phase base value obtained from the integrator 15 so as to calculate a voltage phase θ*. Then, the adder 16 outputs the voltage phase θ* to the PMW controller 17 and the d-q converter 22.

The PMW controller 17 calculates a control signal based on the voltage command V* from the voltage commander 13 and based on the voltage phase θ* from the adder 16. The control signal is used for PMW control of the rotation of the induction motor 2. Then, the PMW controller 17 outputs the control signal to the inverter 3.

The α-β converter 21 performs α-β conversion of a current detection value of the three-phase AC power that the inverter 3 supplies to the induction motor 2 so as to calculate a current detection value in a fixed coordinate system α-β. Then, the α-β converter 21 outputs the current detection value to the d-q converter 22.

The d-q converter 22 uses the voltage phase θ* obtained from the adder 16 to perform d-q conversion of the current detection value in the fixed coordinate system α-β obtained from the α-β converter 21. Thus, the d-q converter 22 calculates a q-axis current value I_{q} and a d-axis current value I_{d} in a rotary coordinate system d-q. Then, the d-q converter 22 outputs the q-axis current value I_{q} and the d-axis current value I_{d} to the evaluation value calculator 61 and the search ending determiner 65. The q-axis current value I_{q} is a torque current component. The d-axis current value I_{d} is an excitation current component.

The motor controller 10 performs the previous search when a switch SW2 is at one side, and performs the evaluation value search when the switch SW2 is at another side. In the speed search, the motor controller 10 performs the previous search first and performs the evaluation value search next.

The previous search 31 is a block to perform the previous search. Examples of the previous search include, but are not limited to, a method of increasing or decreasing frequency based on an induced voltage attributed to a residual magnetic flux that results when the induction motor 2 turns into the free run state, and a method of increasing or decreasing frequency based on an oscillation of a current that results when a DC voltage is applied to the induction motor 2 in the free run state. The methods are conventional techniques and will not be elaborated.

The previous searcher 31 performs the previous search to obtain information indicating the rotational direction of the induction motor 2. Then, the previous searcher 31 outputs the information to the rotational direction setting section 33.

The rotational direction setting section 33 obtains from the previous searcher 31 the information indicating the rotational direction of the induction motor 2, and adds the information to a frequency command ωₛₑₐᵣ*, which is obtained from the evaluation value searcher 63.

The evaluation value calculator 61 calculates an evaluation value J based on the q-axis current value I_{q} and the d-axis current I_{d} obtained from the d-q converter 22, and outputs the evaluation value J to the evaluation value searcher 63. The calculation of the evaluation value J will be described in detail later.

The evaluation value searcher 63 calculates the frequency command ωₛₑₐᵣ* based on the evaluation value J obtained from the evaluation value calculator 61, and outputs the frequency command ωₛₑₐᵣ* to the V/F converter 11 and the voltage phase section 14. The evaluation value searcher 63 will be described in detail later.

Based on the q-axis current value I_{q} and the d-axis current I_{d} obtained from the d-q converter 22, the search ending determiner 65 determines whether to end the evaluation value search. For example, the search ending determiner 65 determines to end the evaluation value search when the q-axis current value I_{q} is below a threshold.

The search ending determiner 65 may determine whether to end the evaluation value search based on the evaluation value J calculated by the evaluation value calculator 61 (here, the search ending determiner 65 serves as a closeness determiner).

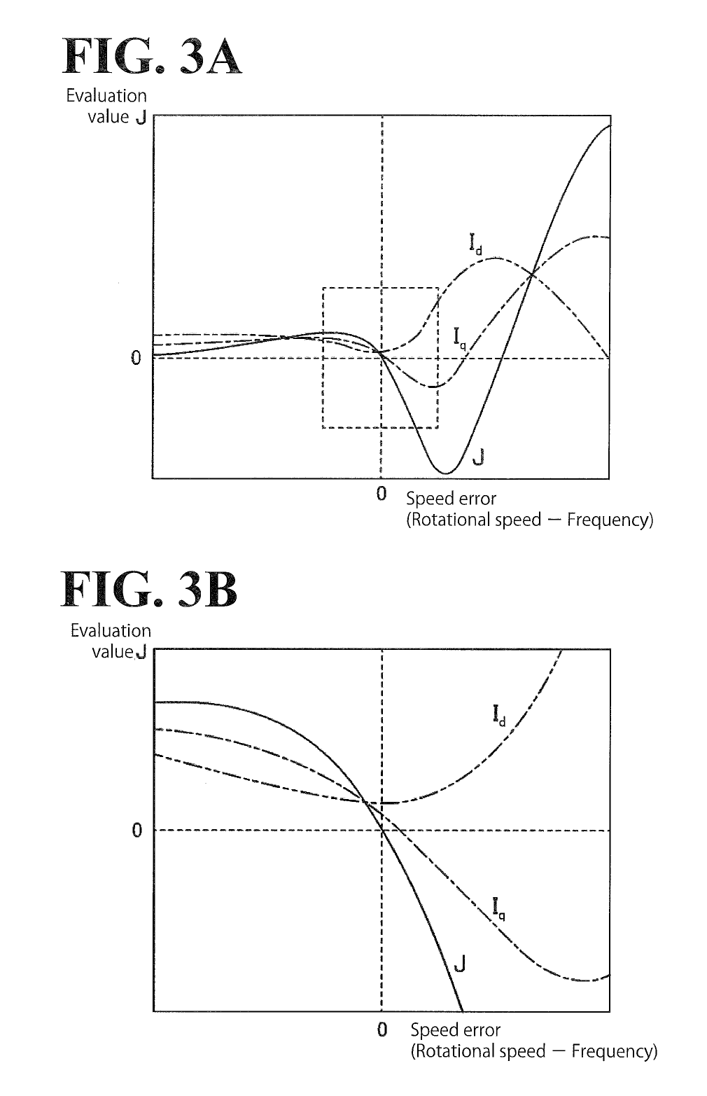

FIG. 3A is a graph of an exemplary function representing the evaluation value J. FIG. 3B is an enlarged graph of a main part of FIG. 3A. The main part is surrounded by a broken line frame at a center portion of FIG. 3A.

As illustrated in each graph, the vertical axis represents the evaluation value J, while the horizontal axis represents speed error. The speed error is a difference between the rotational speed of the induction motor 2 and the frequency of the voltage applied to the induction motor 2. Also as illustrated in each graph, the solid line represents a function of the evaluation value J, the single-dashed line represents the q-axis current value I_{q}, and the double-dashed line represents the d-axis current value I_{d}.

The following Formula 1 is an example of the function of the evaluation value J. K represents a weighting factor (0<K<1). In the function of the evaluation value J illustrated in the graphs, K=0.5.

J=−(1−K)(I_{d}−I_{q})+K·I_{q} [Formula 1]

The function of the evaluation value J includes the q-axis current value I_{q} and the d-axis current value I_{d}. It should be noted that the function of the evaluation value J may not include the d-axis current value I_{d} (for example, when K=1 in Formula 1, a function with the q-axis current value I_{q} and without the d-axis current value I_{d} results).

The function of the evaluation value J has one sign among the positive sign and the negative sign when the speed error is a predetermined positive value, and has another sign different from the one sign among the positive sign and the negative sign when the speed error is a predetermined negative value. For example, the evaluation value J shows a different sign, the positive sign or the negative sign, at one end (for example, 5 Hz) and the other end (for example, −5 Hz) of the range of the speed error illustrated in FIG. 3B. It is particularly preferred that the sign of the evaluation value J be reversed between the positive sign and the negative sign when the speed error is approximately 0.

The function of the evaluation value J linearly changes between the predetermined positive value and the predetermined negative value of the speed error. For example, the evaluation value J linearly changes in a part including 0 of the speed range illustrated in FIG. 3B (for example, −2 Hz to 2 Hz). It is particularly preferred that the function of the evaluation value J linearly change to 0 when the speed error is approximately 0.

In the function of the evaluation value J, the sign of the evaluation value J is reversed between the positive sign and the negative sign when the speed error is approximately 0. This makes it easier to make the frequency of the voltage applied to the induction motor 2 close to the rotational speed of the induction motor 2. For example, it is possible to increase the frequency when the evaluation value J has one of the positive sign and the negative sign, and to decrease the frequency when the evaluation value J has the other one of the positive sign and the negative sign.

When K=1, the function of the evaluation value J is I_{q}. In this case, the evaluation value J changes to 0 when the speed error is further at the regeneration side than 0. That is, the evaluation value J changes to 0 when the rotational speed is greater than the frequency (that is, at the right side in FIG. 3). In this case, if the frequency is controlled to make the evaluation value J change to 0, the frequency converges further at the regeneration side than the actual rotational speed.

When K=0, the function of the evaluation value J is I_{d}−I_{q}. In this case, the evaluation value J changes to 0 when the speed error is further at the electromotion side than 0. That is, the evaluation value J changes to 0 when the rotational speed is smaller than the frequency (that is, at the left side in FIG. 3). In this case, if the frequency is controlled to make the evaluation value J change to 0, the frequency converges further at the electromotion side than the actual rotational speed.

The function of the evaluation value J may include a q-axis power value P_{q} and a d-axis power value P_{d} instead of the q-axis current value I_{q} and the d-axis current value I_{d}. Since power value P is obtained by multiplying a current value I and a voltage value V together, the relationship indicated in Formula 1 remains unchanged even when the q-axis current value I_{q} and the d-axis current value I_{d} are replaced with the q-axis power value P_{q} and the d-axis power value P_{d}.

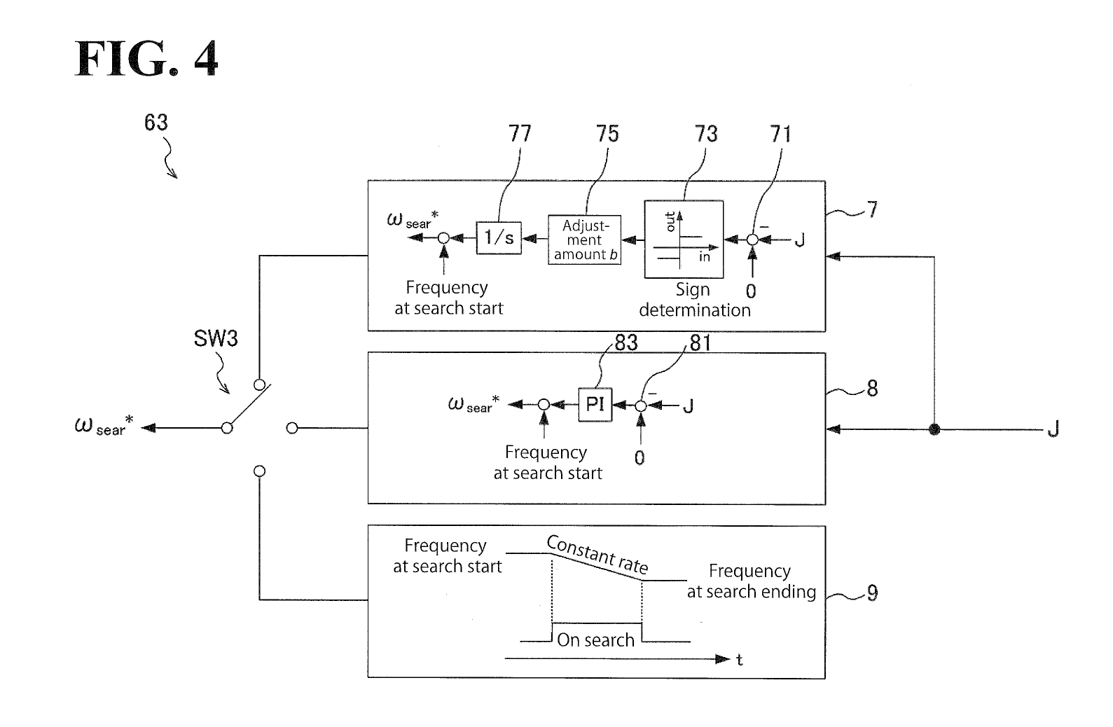

FIG. 4 is a block diagram illustrating an example of the evaluation value searcher 63. The evaluation value searcher 63 includes a first evaluation value searcher 7, a second evaluation value searcher 8, and a third evaluation value searcher 9. A switch SW3 switches the output of the evaluation value searcher 63 among the first to third evaluation value searchers 7 to 9.

The first evaluation value searcher 7 and the second evaluation value searcher 8 are blocks to increase or decrease the frequency based on whether the evaluation value J has the positive sign or the negative sign so as to cause the evaluation value J to converge at approximately 0.

The first evaluation value searcher 7 includes a subtractor 71, a sign determiner 73, a multiplier 75, and an integrator 77. The first evaluation value searcher 7 performs hysteresis control.

When the evaluation value J is input, the subtractor 71 performs a calculation to reverse the positive sign of the input evaluation value J into the negative sign, thus obtaining −J. Then, the subtractor 71 outputs the −J to the sign determiner 73.

When the −J from the subtractor 71 is positive, the sign determiner 73 outputs a predetermined positive value to the multiplier 75. When the −J from the subtractor 71 is negative, the sign determiner 73 outputs a predetermined negative value to the multiplier 75.

The multiplier 75 multiplies the predetermined positive value or the predetermined negative value obtained from the sign determiner 73 by an adjustment value b, and outputs the product to the integrator 77.

The integrator 77 integrates the product obtained from the multiplier 75 and outputs the integrated value as the frequency command ωₛₑₐᵣ*.

The frequency at the start of the search is the frequency at the end of the previous search performed by the previous searcher 31.

The first evaluation value searcher 7 ensures promptness in making the frequency command ωₛₑₐᵣ* close to the rotational speed of the induction motor 2 while reducing the load of calculating the frequency command ωₛₑₐᵣ*.

The second evaluation value searcher 8 includes a subtractor 81 and a PI controller 83. The second evaluation value searcher 8 performs a PI control mode.

When the evaluation value J is input, the subtractor 81 performs a calculation to reverse the positive sign of the input evaluation value J into the negative sign, thus obtaining −J. Then, the subtractor 81 outputs the −J to the PI controller 83.

The PI controller 83 performs PI control to calculate the frequency command ωₛₑₐᵣ* to cause the −J from the subtractor 81 to converge at 0. Then, the PI controller 83 outputs the frequency command ωₛₑₐᵣ*.

The second evaluation value searcher 8 ensures accuracy in making the frequency command ωₛₑₐᵣ* close to the rotational speed of the induction motor 2.

The third evaluation value searcher 9 changes the frequency command ωₛₑₐᵣ*. from the frequency at the start of the search by a predetermined rate.

The third evaluation value searcher 9 ends the search when the evaluation value J converges at approximately 0.

The third evaluation value searcher 9 ensures accuracy in making the frequency command ωₛₑₐᵣ* close to the rotational speed of the induction motor 2.

The evaluation value searcher 63 selectively uses one of the evaluation value searchers 7 to 9 to cause the evaluation value J to converge at approximately 0. For example, it is possible to first perform the hysteresis control using the first evaluation value searcher 7 and then perform the PI control mode using the second evaluation value searcher 8. This ensures promptness and accuracy in making the frequency command ωₛₑₐᵣ* close to the rotational speed of the induction motor 2.

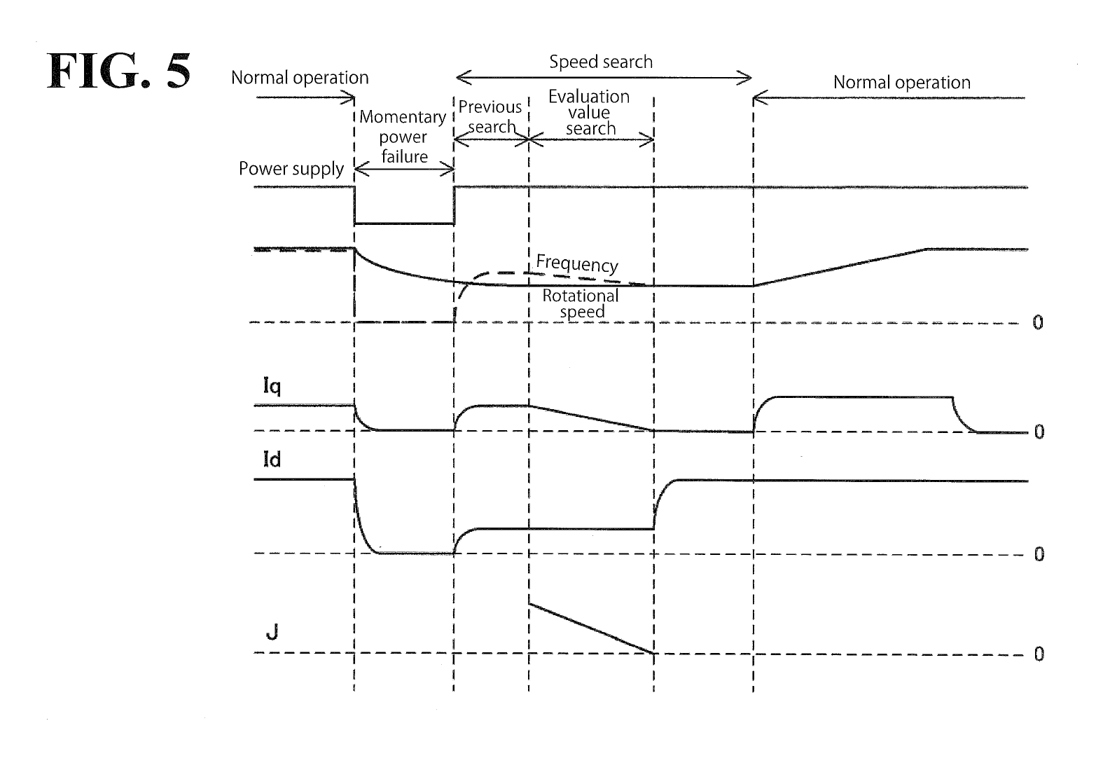

FIG. 5 is a time chart illustrating an exemplary speed search. FIG. 5 illustrates a flow of a momentary power failure followed by the speed search and the normal operation.

When a momentary power failure occurs, the output of the inverter 3 stops and the induction motor 2 turns into the free run state. Then, the rotational speed gradually decreases.

When power supply resumes, the motor controller 10 starts the speed search to make the frequency of the voltage applied to the induction motor 2 close to the rotational speed of the induction motor 2. In the speed search, the motor controller 10 performs the previous search first and performs the evaluation value search next.

The motor controller 10 performs the previous search. The frequency at the end of the previous search is the frequency at the start of the evaluation value search. The motor controller 10 determines the rotational direction of the induction motor 2. The determination as to the rotational direction of the induction motor 2 is made at the end of the previous search.

In the evaluation value search, the motor controller 10 increases or decreases the frequency based on whether the evaluation value J has the positive sign or the negative sign, so as to cause the evaluation value J to converge at approximately 0. Thus, the frequency gradually becomes closer to the rotational speed. The evaluation value search is as described above. The evaluation value search ends when the evaluation value J converges at approximately 0.

After the evaluation value search, the motor controller 10 adjusts the gain a (see FIG. 2) while keeping the frequency unchanged, so as to restore the applied voltage. Then, the motor controller 10 turns into the normal operation.

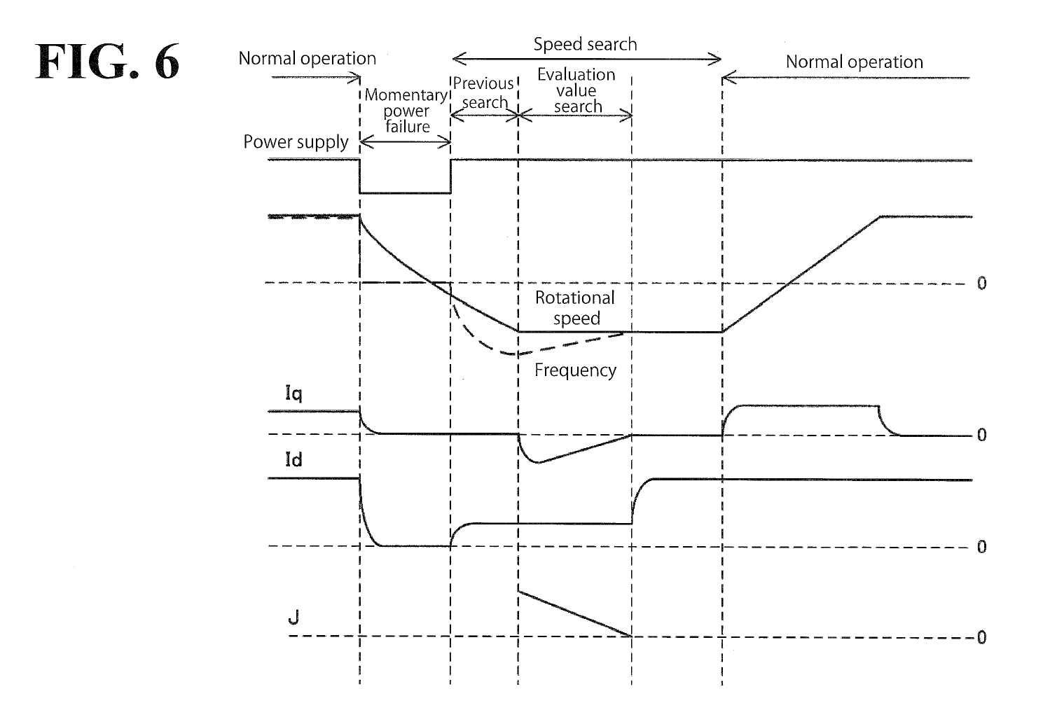

FIG. 6 is a time chart illustrating an exemplary speed search. The following description is concerning those respects different from FIG. 5.

FIG. 6 illustrates a state in which the rotational speed of the induction motor 2 in the free run state has a negative value (that is, a state in which the rotational direction is reversed). In the previous search, the motor controller 10 makes the rotational speed of negative value close to the frequency. In the evaluation value search, the motor controller 10 makes the rotational speed closer to the frequency. In the estimation of the frequency in the evaluation value search, the rotational direction found in the previous search is added to the frequency, as described above (see FIG. 2). This ensures estimation of the frequency based on a correct rotational direction.

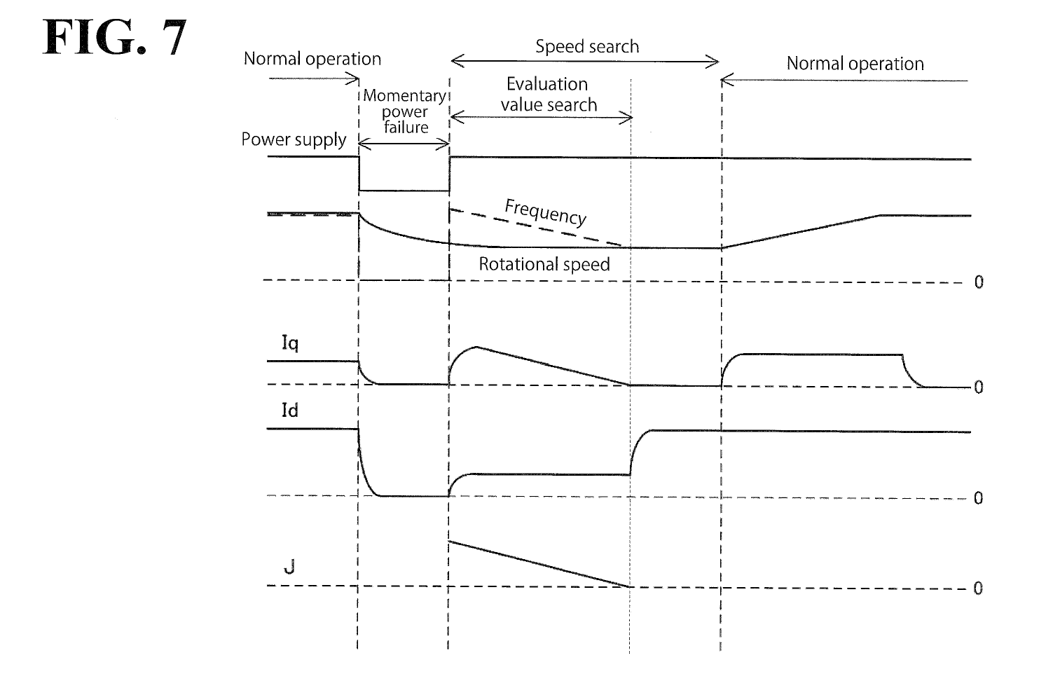

FIG. 7 is a time chart illustrating an exemplary speed search. The following description is concerning those respects different from FIG. 5 or 6.

FIG. 7 illustrates a state in which no previous search is performed; instead the evaluation value search is performed at the start of the speed search. In this example, the rotational direction of the induction motor 2 and the frequency at the start are set in advance, and the evaluation value search is performed based on these rotational direction and frequency. For example, when the rotational direction of the induction motor 2 is positive and the frequency at the start of the search is maximum, then the motor controller 10 starts decreasing the frequency from the maximum toward 0, and finally causes the evaluation value J to converge at approximately 0.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A motor controller comprising:
an evaluation value calculator configured to calculate an evaluation value represented by a function comprising a q-axis current value of a torque current component of a current through an induction motor, the evaluation value having a first sign among a positive sign and a negative sign when a rotational speed of the induction motor is greater than a frequency of a voltage applied to the induction motor by a predetermined amount, the evaluation value having a second sign different from the first sign among the positive sign and the negative sign when the rotational speed is smaller than the frequency by the predetermined amount; and
an evaluation value searcher configured to perform an evaluation value search to increase or decrease the frequency based on whether the evaluation value has the positive sign or the negative sign so as to make the frequency close to the rotational speed of the induction motor in a free run state.

2. The motor controller according to claim 1, wherein the function representing the evaluation value comprises the q-axis current value and a d-axis value of an excitation current component of the current through the induction motor.

3. The motor controller according to claim 1, wherein the function representing the evaluation value linearly changes between a case of the rotational speed being greater than the frequency by the predetermined value and a case of the rotational speed being smaller than the frequency by the predetermined value.

4. The motor controller according to claim 1, further comprising a closeness determiner configured to determine, in accordance with the evaluation value, whether the frequency is close to the rotational speed.

5. The motor controller according to claim 1, further comprising a previous searcher configured to perform at least one of a first search and a second search before the evaluation value search, the first search being to increase or decrease the frequency based on an induced voltage attributed to a residual magnetic flux that results when the induction motor turns into the free run state, the second search being to increase or decrease the frequency based on an oscillation of a current that results when a DC voltage is applied to the induction motor in the free run state.

6. The motor controller according to claim 1, wherein the function representing the evaluation value linearly changes to 0 when a difference between the rotational speed and the frequency is approximately 0.

7. A motor controller comprising:
a previous searcher configured to perform at least one of a first search and a second search, the first search being to increase or decrease a frequency of a voltage applied to an induction motor based on an induced voltage attributed to a residual magnetic flux that results when the induction motor turns into a free run state, the second search being to increase or decrease the frequency based on an oscillation of a current that results when a DC voltage is applied to the induction motor in the free run state; and
a post-searcher configured to perform a third search after the at least one of the first search and the second search, the third search being to increase or decrease the frequency based on a q-axis current value of a torque current component of a current through the induction motor so as to make the frequency close to a rotational speed of the induction motor in the free run state.

8. A motor controller comprising:
an evaluation value calculator configured to calculate an evaluation value represented by a function comprising a q-axis power value of a torque power component of power supplied to an induction motor, the evaluation value having a first sign among a positive sign and a negative sign when a rotational speed of the induction motor is greater than a frequency of a voltage applied to the induction motor by a predetermined amount, the evaluation value having a second sign different from the first sign among the positive sign and the negative sign when the rotational speed is smaller than the frequency by the predetermined amount; and
an evaluation value searcher configured to perform an evaluation value search to increase or decrease the frequency based on whether the evaluation value has the positive sign or the negative sign so as to make the frequency close to the rotational speed of the induction motor in a free run state.

9. A method for controlling a motor, the method comprising:
calculating an evaluation value represented by a function comprising a q-axis current value of a torque current component of a current through an induction motor, the evaluation value having a first sign among a positive sign and a negative sign when a rotational speed of the induction motor is greater than a frequency of a voltage applied to the induction motor by a predetermined amount, the evaluation value having a second sign different from the first sign among the positive sign and the negative sign when the rotational speed is smaller than the frequency by the predetermined amount; and
performing an evaluation value search to increase or decrease the frequency based on whether the evaluation value has the positive sign or the negative sign so as to make the frequency close to the rotational speed of the induction motor in a free run state.

10. A motor controller comprising:
evaluation value calculating means for calculating an evaluation value represented by a function comprising a q-axis current value of a torque current component of a current through the induction motor, the evaluation value having a first sign among a positive sign and a negative sign when a rotational speed of the induction motor is greater than a frequency of a voltage applied to the induction motor by a predetermined amount, the evaluation value having a second sign different from the first sign among the positive sign and the negative sign when the rotational speed is smaller than the frequency by the predetermined amount; and
evaluation value searching means for performing an evaluation value search to increase or decrease the frequency based on whether the evaluation value has the positive sign or the negative sign so as to make the frequency close to the rotational speed of the induction motor in a free run state.
